(19) United States
(12) Patent Application Publication
(10) Pub. No.: US 2011/0307303 A1
(43) Pub. Date: Dec. 15, 2011

(54) DETERMINING EMPLOYEE CHARACTERISTICS USING PREDICTIVE ANALYTICS

(75) Inventors: Debasis DUTTA, Kolkata (IN); Brian GASPAR, Mountain View, CA (US); Julian CHALLENGER, Reading (GB); Dinesh ARORA, Cupertino, CA (US)

(73) Assignee: ORACLE INTERNATIONAL CORPORATION, Redwood Shores, CA (US)

(21) Appl. No.: 12/814,756

(22) Filed: Jun. 14, 2010

(51) Int. Cl. G06Q 10/00; G06F 17/30

(52) U.S. Cl. 705/7.42; 707/776; 707/E17.014

(57) ABSTRACT

A computer-implemented method for predicting a future characteristic of a worker is provided. The method includes collecting a plurality of attributes associated with each of a plurality of workers, applying a data mining tool to the attributes to identify a pattern between the attributes and a future characteristic of the workers, and using the identified pattern to predict the future characteristic of a worker. In one example, the future characteristic is the future performance of the employee and/or the likelihood that the worker leaves at some point in the future.

### BACKGROUND

1. Field

Embodiments of the invention are generally related to computer systems and, in particular, human resource or human capital management systems.

2. Description of the Related Art

Human resource management generally refers to the strategic processes organizations use to manage people. Organizations utilize human resource management processes to attract appropriately skilled employees, integrate them into the organization, assess and develop their competencies, and retain their commitment. In order to achieve these goals, companies may implement several processes including workforce planning, recruitment, orientation, skills management and training, salary compensation and benefits administration, and performance appraisal. Therefore, the human resources management function of an organization includes a variety of activities, such as deciding staffing needs and determining how to fulfill them, recruiting and training the best employees, ensuring they are and continue to be high performers, addressing performance issues, developing and managing an approach to employee benefits and compensation, and ensuring that personnel and management practices conform to various regulations.

Given the breadth and complexity of human resource management functions, companies utilize information technology systems and/or software applications to help manage and streamline the process. These applications allow enterprises to automate many aspects of human resource (HR) management, with the dual benefits of reducing the workload of the HR department as well as increasing the efficiency of the department by standardizing HR processes. An example of such a human resource management application is the Human Capital Management (HCM) Fusion® application from Oracle® Corporation.

### SUMMARY

According to one embodiment, a computer-implemented method for predicting a future characteristic of a worker is provided. The method includes collecting a plurality of attributes associated with each of a plurality of workers, applying a data mining tool to the attributes to identify a pattern between the attributes and a future characteristic of the workers, and using the identified pattern to predict the future characteristic of a worker. In one example, the future characteristic is the future performance of the worker and/or the likelihood that the worker leaves at some point in the future.

### BRIEF DESCRIPTION OF THE DRAWINGS

For proper understanding of the invention, reference should be made to the accompanying drawings, wherein:

FIG. 1 illustrates a block diagram of a system according to one embodiment of the invention;

FIG. 2 illustrates a flow chart of a method according to one embodiment;

FIG. 3 illustrates a flow chart of a method according to another embodiment;

FIG. 4 illustrates a user interface according to one embodiment;

FIG. 5a illustrates a user interface according to an embodiment;

FIG. 5b illustrates a user interface according to another embodiment;

FIG. 6 illustrates a user interface according to an embodiment;

FIG. 7 illustrates a user interface according to an embodiment;

FIG. 8a illustrates a user interface according to an embodiment;

FIG. 8b illustrates a user interface according to another embodiment;

FIG. 9 illustrates a user interface according to an embodiment;

FIG. 10 illustrates a user interface according to an embodiment;

FIG. 11 illustrates a user interface according to an embodiment;

FIG. 12 illustrates a user interface according to one embodiment;

FIG. 13a illustrates a user interface according to an embodiment; and

FIG. 13b illustrates a user interface according to another embodiment.

### DETAILED DESCRIPTION

Many employers and organizations face issues with top performing employees leaving to join competitors without warning. Organizations may also face a similar problem with the performance of employees diminishing thereby resulting in a loss of productivity. Both of these issues may result in a high cost of replacement of employees in terms of time and money. Therefore, embodiments of the invention provide a system which can apply advanced statistical methods and data mining to predict the chance of future attrition and the potential of an individual associated with the organization or for a group of employees.

More specifically, one embodiment is directed to a system for predicting future performance and/or the likelihood of attrition for a worker. The worker may be an employee, contingent worker, contractor, or any individual associated with an organization. The system is configured to collect attributes associated with the workers in the organization. The attributes may be related to the worker's background, as well as their job responsibilities, past performance, compensation, and any other relevant attributes. The system is then configured to apply a data mining model to those attributes. The data mining model analyzes the attributes as they relate to all workers and identifies a pattern between the attributes and the future performance of the workers or their likelihood of attrition. The system is further configured to use the identified pattern to predict future performance or likelihood of attrition for a specific worker. In an embodiment, the system is included within a human resource management application, such as the Human Capital Management (HCM) Fusion® application from Oracle® Corporation.

In one example, the system is able to mine existing worker data using data mining tools in order to predict a worker's risk of leaving and the future performance levels of the current workforce. Additionally, the system, via the data mining tool, can identify the top reasons that contribute positively or negatively in deriving the prediction value. In other words, the system can identify the specific attributes that most contribute to the prediction.

As a result, when retention and performance issues arise with respect to certain employees, the organization's human resource system is able to predict, forewarn, and help managers to take corrective actions to improve organizational stability and thereby increase overall productivity. By providing such predictions, embodiments of the invention will result in a substantial cost savings in terms of replacement cost and time needed to hire a comparable replacement worker, as well as the time required to bring that new worker up to speed and producing at the desired level of productivity.

Additionally, other embodiments of the invention provide a system for identifying and predicting the impact of a personnel action on an individual worker or employee and their peers. For example, the system may provide a manager with a prediction of a result of some action, such as a promotion or salary increase, before such action is taken. Thus, the system will provide valuable insight into the decision making process for a personnel action and how it may affect retention and performance of the worker and their peers.

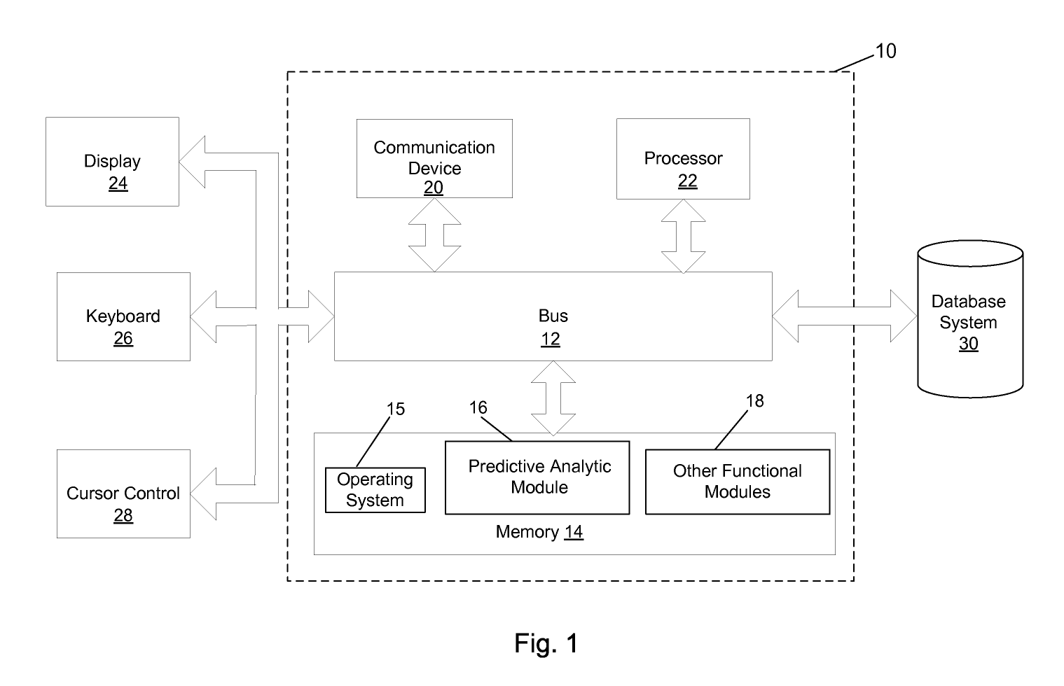

FIG. 1 illustrates a block diagram of a system 10 that may implement one embodiment of the invention. System 10 includes a bus 12 or other communications mechanism for communicating information between components of system 10. System 10 also includes a processor 22, coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer readable media. System 10 further includes a communication device 20, such as a network interface card or other communications interface, to provide access to a network. As a result, a user may interface with system 10 directly or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user, such as configuration information. A keyboard 26 and a cursor control device 28, such as a computer mouse, are further coupled to bus 12 to enable a user to interface with system 10. Processor 22 and memory 14 may also be coupled via bus 12 to a database system 30 and, thus, may be able to access and retrieve information stored in database system 30. Although only a single database is illustrated in FIG. 1, any number of databases may be used in accordance with certain embodiments. In some embodiments, database system 30 may store employee data, such as job responsibilities, past performance, compensation, and any other relevant attributes.

In one embodiment, memory 14 stores software modules that provide functionality when executed by processor 22. The modules may include an operating system 15 that provides operating system functionality for system 10. The memory may also store a predictive analytic module 16, which provides a prediction of the future performance and/or likelihood of attrition of a worker or employee.

In one embodiment, predictive analytic module 16 is configured to collect and analyze attributes associated with company employees. The attributes may be related to an employee's background, their job responsibilities, past performance, compensation, and any other relevant attributes. Predictive analytic module 16 applies a data mining model to those attributes. The data mining model analyzes the attributes as they relate to all employees and identifies a pattern between the attributes and the future performance of the employees or their likelihood of attrition. Predictive analytic module 16 is further configured to use the identified pattern to the predict future performance or likelihood of attrition for a specific employee. In addition, predictive analytic module 16 can be configurable by users to take into account additional attributes, to remove existing attributes, or to weight certain attributes differently.

In other embodiments, predictive analytic module 16 can provide a predicted result of some personnel action on the employee and their peers. For instance, a manager may be considering providing an employee with a salary increase or promotion. Prior to finalizing such an action, the manager may input the contemplated action into system 10, and predictive analytic module 16 will provide a prediction of the likely result of the action. As a result, the manager will have more complete and tangible information regarding the result of the action on the employee and their peers thereby allowing the manager to make a more informed decision.

System 10 may also include one or more other functional modules 18 to provide additional functionality. For example, functional modules 18 may include a human capital management application module or any modules related to an enterprise human resource system.

Database system 30 may include a database server and any type of database, such as a relational or flat file database. Database system 30 may store attributes related to employees including their background, responsibilities, performance and compensation. Database system 30 may also store any other data required by the predictive analytic module 16, or data associated with system 10 and its associated modules and components.

In certain embodiments, processor 22, predictive analytic module 16, and other functional modules 18 may be implemented as separate physical and logical units or may be implemented in a single physical and logical unit. Furthermore, in some embodiments, processor 22, predictive analytic module 16, and other functional modules 18 may be implemented in hardware, or as any suitable combination of hardware and software.

As mentioned above, embodiments of the invention utilize a number of employee attributes to produce a prediction of future employee performance and/or future likelihood of attrition. The attributes can be configured by users according to their requirements, including removing or adding certain attributes from the analysis. Table 1 illustrates examples of some of the attributes that may be used to compile the predictions.

TABLE 1

| Attribute | Description |
|---|---|
| Amount of leave in the previous year | Number of days leave in the previous year |
| Amount of sickness | Number of days sickness in the current year |
| Amount of sickness in the previous | Number of days sickness in the previous |
| year | year |
| Appraising manager | Appraising manager |
| Average salary change | Average % change |
| Current assignment status | Assignment status |
| Current business group | Business group |
| Current department | Department |
| Current grade | Grade |
| Current job | Job |
| Current location | Location |
| Current manager | Manager |
| Current manager | Current manager |
| Current position | Position |
| Expected working hours | Expected weekly working hours |
| FTE (full time equivalent) | FTE value |
| Has a second passport | |
| Home city | Home city |
| Home country | Home country |
| Increase in sickness over previous | |
| year | |
| Legal entity | Legal entity |
| Legislation | Legislation |
| Length of service | Length of service in years |
| Length of time since last received | Length of time since received options in |
| options | months |
| Length of time since last salary | Length of time since last salary change in |
| change | months |
| Manager's performance | Manager's overall performance rating |
| Most recent salary change | % change in salary for the most recent |
| | change |
| Nationality | Nationality |
| Normal working end time | Normal working end time |
| Normal working start time | Normal working start time |
| Number of days leave taken while at | Number of days leave |
| this enterprise | |
| Number of different departments | Count of the number of different |
| worked in | departments |
| Number of different grades | Count of the number of different grades |
| Number of grade changes in the last 2 | Count of the number of grade changes in the |
| years | last 2 calendar years |
| Number of managers in the last 5 | Count of the number of different manager in |
| years | the last 5 calendar years |
| Number of sicknesses in the previous | Number of distinct sicknesses in the |
| year | previous year (a sickness of 10 days is |
| | counted as 1) |
| Number of stock options compared to | Ratio of number of stock options held vs the |
| others on the same grade | average number of stock options of others |
| | on the same grade |
| Performance has changed | |
| Potential profit on stock | Potential profit on stock expressed in users |
| | currency |
| Previous performance | Previous overall performance rating |
| Previously employed at the enterprise | |
| Ratio of vested vs unvested options | Ratio of vested vs unvested options |
| Reason for last salary change | Salary change reason |
| Tabacco user | |
| Time in current grade | Number of months in current grade |
| Time in current job | Number of months in current job |
| Time since last leave | Number of months since last leave absence |
| Time since last probation ended | Number of months since probation ended |
| Time since last sickness | Number of months since last sickness |
| | absence |
| Time since the marital status last | Number of years since marital status last |
| changed | change |
| Time spent in current department | Number of months in current department |
| Time spent in current position | Number of months in current position |
| Time spent in each department | Average number of months spent in each |
| | department |
| Time spent in each grade | Average number of months spent in each |
| | grade |
| Time spent in each job | Average number of months spent in each job |
| Time spent in each position | Average number of months spent in each |
| | position |
| Time spent with each manager | Average number of months spent in each |
| | manager |
| Time spent with the current manager | Number of months with current manager |
| Time to end of contract | Number of months until the end of contract |
| Time until next salary review | Number of months until next salary review |
| Time until the next performance | Number of months until next performance |
| review | review |
| Visa expiration | Number of weeks until visa expires |
| Willing to relocate domestically | |
| Worker category | Worker category |
| Worker is an employee | |
| Worker is willing to relocate | |
| internationally | |
| Worker's current performance rating | Current overall performance rating |
| Worker's current self performance | Current self assessed performance rating |
| rating | |
| Worker's performance assessment | |
| differs from managers | |
| Worker's performance compared to | Ratio of workers overall performance rating |
| peers | vs the average for peers (i.e. others reporting |
| | directly to the same manager) |
| Worker's stock options compared to | Ratio of the number of stock options vs the |
| peers | average for peers (i.e. others reporting |
| | directly to the same manager) |

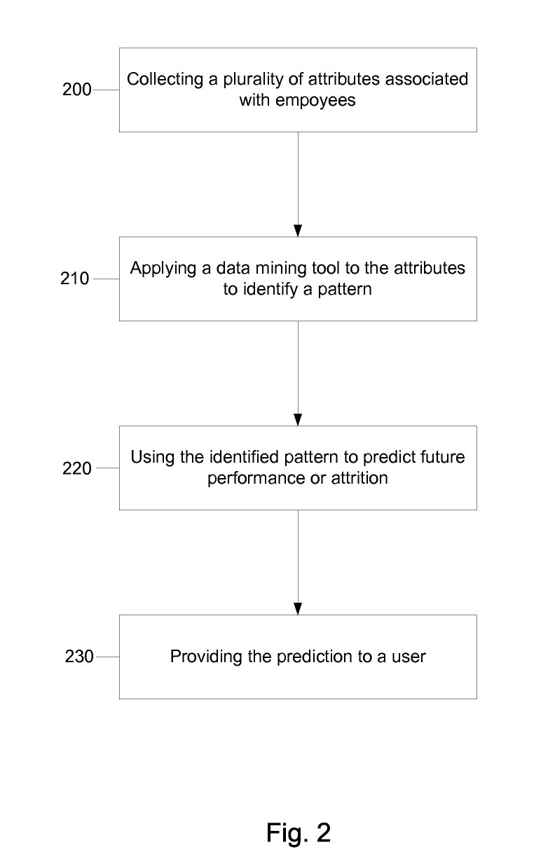

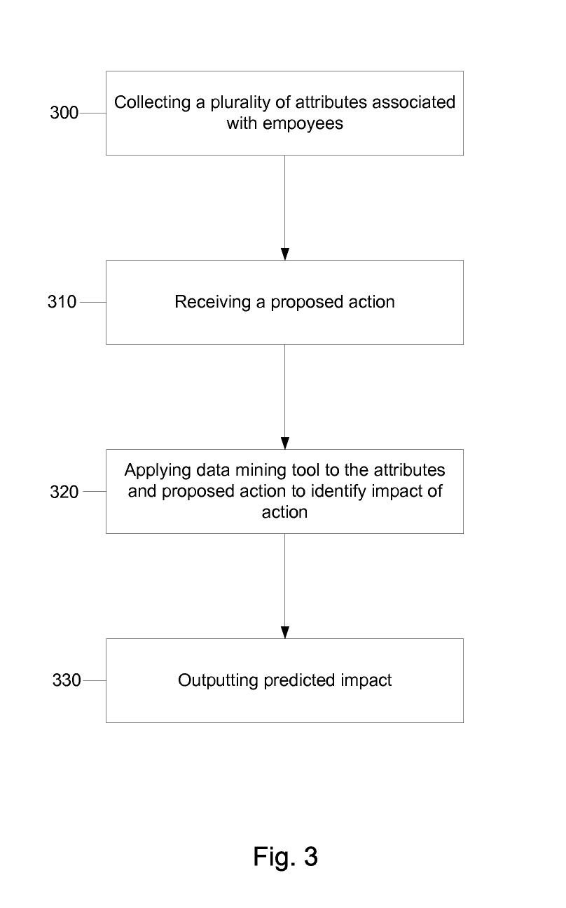

FIG. 2 illustrates a flow diagram of a method according to one embodiment. In some embodiments, the flow diagram of FIG. 2 shows some of the functionality of predictive analytic module 16. In one embodiment, the functionality of the flow diagram of FIG. 2, and FIG. 3 below, is implemented by software stored in memory or other computer readable or tangible media, and executed by a processor. In other embodiments, the functionality may be performed by hardware (e.g. through the use of an application specific integrated circuit (“ASIC”), a programmable gate array (“PGA”), a field programmable gate array (“FPGA”), or any combination of hardware and software.

At 200, a plurality of attributes related to employees of the company are collected. As mentioned above, these attributes may be related to an employee's background, their job responsibilities, past performance, compensation, or any other relevant attributes. At 210, a data mining tool is applied to the attributes in order to identify a pattern between the attributes and the future performance of the employees, or a pattern between the attributes and the future likelihood of attrition of the employees. In some embodiments, when predicting attrition, the data mining tool is controlled, for example by predictive analytic module 16, to identify patterns that resulted in a voluntary termination. Thus, in this case, the data mining tool looks for past cases where the worker was terminated and the termination was of a voluntary nature. The data mining tool can then analyze these cases to find patterns between employee attributes and attrition. Embodiments of the invention can then apply these patterns to current workers to predict their likelihood of attrition.

In other embodiments, when predicting future performance, the data mining tool is controlled to identify patterns that result in the worker's overall performance rating. For example, the data mining tool may identify patterns that are typical for low performing workers and patterns that are typical for high performing workers. Therefore, given a certain target attribute, such as voluntary attrition or high performance, the data mining tool can identify the patterns that resulted in that target attribute.

Then, at 220, the identified pattern is used to predict the future performance or likelihood of attrition of a specific employee. According to one example, the method further includes, at 230, providing the prediction of the future performance or likelihood of attrition of the employee to a user of system 10, such as a human resources manager. The prediction may be provided to the user via a graphical user interface, such as a table or graph.

In this embodiment, data mining is used as a tool in the process of predicting a future characteristic of an employee, such as their future performance or their likelihood of leaving the organization. In general, data mining refers to the process of extracting patterns from data. Two commonly used data mining techniques are classification and regression. The classification technique arranges the data into predefined groups and is therefore the most commonly used technique for predicting a specific outcome such as yes/no, high/medium/low-value, etc. Some classification algorithms include Naive Bayes, Decision Tree, Logistic Regression, and Support Vector Machine (“SVM”).

The regression technique attempts to find a function which models the data with the least error. Accordingly, regression is a technique for predicting a continuous numerical outcome such as customer lifetime value, house value, process yield rates, etc. Some regression algorithms include Multiple Regression and Support Vector Machine (“SVM”).

One embodiment of the invention provides at least two predictions: a predicted risk of leaving (attrition), and a predicted performance. The predicted risk of leaving predicts who is going to leave based on the distribution of attributes of ex-employees and current employees. This prediction utilizes most or all of the attributes outlined in Table 1. Additionally, according to one embodiment, the risk of leaving is predicted using a classification technique such as Generalized Linear Modeling (“GLM”).

Generalized Linear Models (“GLMs”) include and extend the class of linear models provided by Linear Regression. Linear models make a set of restrictive assumptions, most importantly, that the target (dependent variable y) is normally distributed conditioned on the value of predictors with a constant variance regardless of the predicted response value. An advantage of linear models and their restrictions include computational simplicity, an interpretable model form, and the ability to compute certain diagnostic information about the quality of the fit.

GLMs relax these restrictions, which are often violated in practice. For example, binary (yes/no or 0/1) responses do not have the same variance across classes. Furthermore, the sum of terms in a linear model can typically have very large ranges encompassing very negative and very positive values. For the binary response example, it is preferred that the response is a probability in the range [0, 1].

GLMs accommodate responses that violate the linear model assumptions through two mechanisms: a link function and a variance function. The link function transforms the target range to potentially −infinity to +infinity so that the simple form of linear models can be maintained. The variance function expresses the variance as a function of the predicted response, thereby accommodating responses with non-constant variances (such as the binary responses).

Two of the most popular members of the GLM family of models (with their most popular link and variance functions) include: linear regression with the identity link and variance function equal to the constant 1 (constant variance over the range of response values); and logistic regression with the logit link and binomial variance functions.

GLM is a parametric modeling technique. Parametric models make assumptions about the distribution of the data. When the assumptions are met, parametric models can be more efficient than non-parametric models.

The predicted performance of an employee predicts a future value of a worker based on their actual performance as well as all the other attributes outlined in Table 1. In one embodiment, the future performance or value of an employee is predicted using a regression technique such as Support Vector Machine (“SVM”).

SVM is a powerful, state-of-the-art algorithm with strong theoretical foundations based on the Vapnik-Chervonenkis theory. SVM has strong regularization properties. Regularization refers to the generalization of the model to new data.

SVM models have similar functional form to neural networks and radial basis functions, which are both popular data mining techniques. However, neural networks and radial basis algorithms do not have the well-founded theoretical approach to regularization that forms the basis of SVM. The quality of generalization and ease of training of SVM is beyond the capacities of these more traditional methods. SVM can model complex, real-world problems such as text and image classification, hand-writing recognition, and bioinformatics and biosequence analysis.

SVM performs well on data sets that have many attributes, even if there are very few cases on which to train the model. There is no upper limit on the number of attributes; the only constraints are those imposed by hardware. Traditional neural networks, on the other hand, do not perform well under these circumstances.

FIG. 3 illustrates a flow diagram of a method according to another embodiment. The flow diagram of FIG. 3 shows some of the functionality of predictive analytic module 16. More specifically, FIG. 3 illustrates a method of predicting a result of a personnel action on an employee and their group prior to taking that action.

At 300, a plurality of attributes related to employees of the company are collected. These attributes include at least the attributes listed in Table 1. At 310, a proposed personnel action is received. The proposed personnel action can be, for example, a salary increase/decrease or a promotion/demotion. At 320, a data mining tool is applied to the attributes and the proposed personnel action in order to identify an impact of the proposed personnel action on the performance of the employee and/or their peers. Then, at 330, the method includes outputting the impact of the proposed personnel action based on the result produced by the data mining tool. In one example, the predicted impact is provided to the user via a graphical user interface, such as a table or graph.

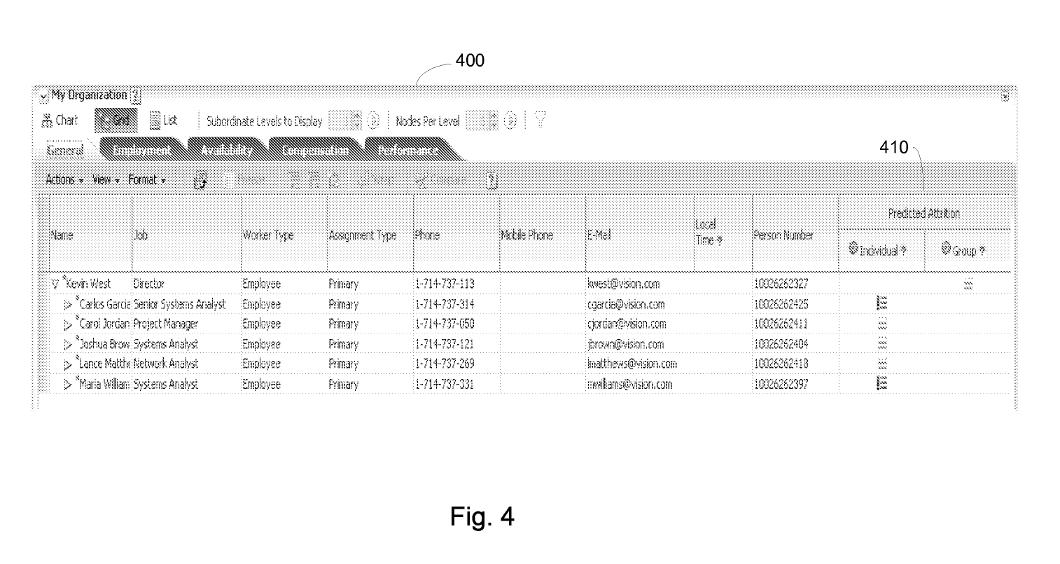

FIG. 4 illustrates an example of an organizational summary user interface 400 which can show the predicted attrition for employees of the organization. Organizational summary user interface 400 includes a page or table that lists the employee's name, job title, worker type, assignment type, telephone number, mobile telephone number, e-mail, local time, and identification number. In addition, organizational summary user interface 400 includes a predicted attrition section 410 that shows the likelihood of an employee leaving. Predicted attrition section 410 includes an “Individual” column which shows the predicted attrition for each of the individual workers as high, medium or low. Predicted attrition section 410 also includes a “Group” column that shows the average predicted attrition for everyone in that worker's team.

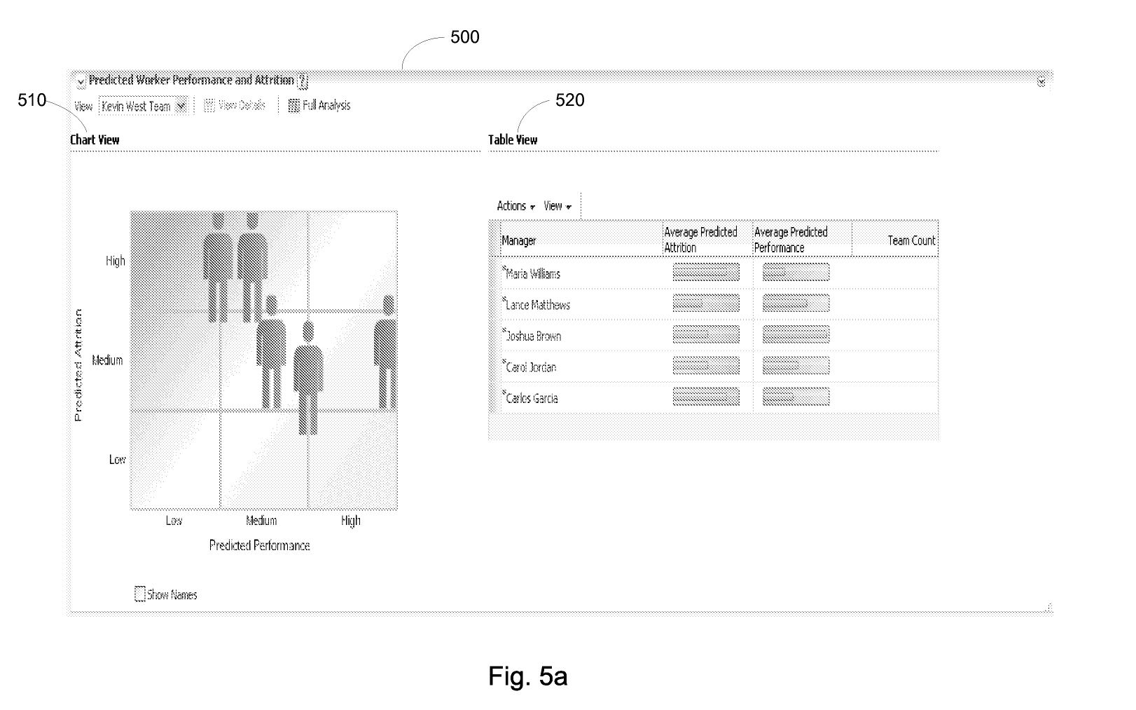

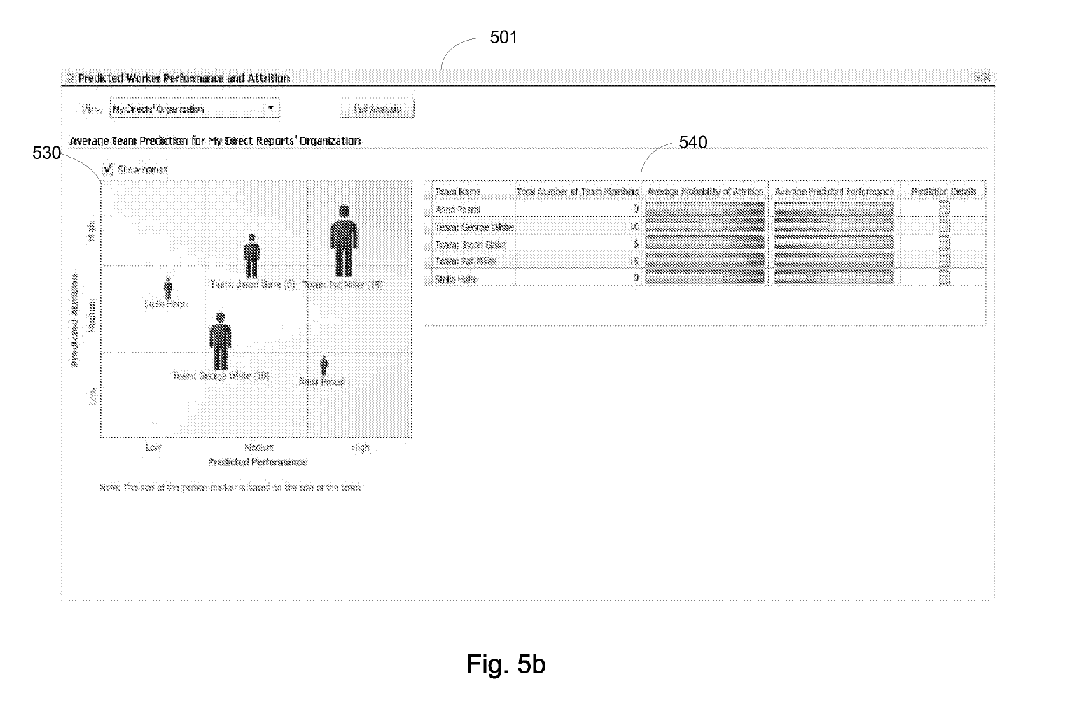

FIG. 5a illustrates an example of a predicted worker performance and attrition user interface 500 that shows the predicted performance and attrition for each worker in a team or group. Predicted worker performance and attrition user interface 500 includes a chart view 510 which graphically represents the predicted attrition and predicted performance for each worker in an XY chart. The y-axis of chart view 510 shows the predicted attrition, while the x-axis shows the predicted performance. Predicted worker performance and attrition user interface 500 also includes a table view 510 that lists each of the workers, their average predicted attrition level, and their average predicted performance level in a table format. Predicted worker performance and attrition user interface 500 allows managers to easily identify those employees or teams that are predicted high performers and are also predicted to be at a high risk of loss. As a result, managers are able to take necessary steps to retain those employees or groups before they make a decision to leave.

FIG. 5b illustrates another example of a predicted worker performance and attrition user interface 501 that shows the predicted performance and attrition for a team or group of workers. Predicted worker performance and attrition user interface 501 includes a chart view 530 which graphically represents the predicted attrition and predicted performance for each team in an XY chart. Similar to FIG. 5a, the y-axis of chart view 530 shows the predicted attrition, while the x-axis shows the predicted performance. Predicted worker performance and attrition user interface 501 also includes a table view 540 that lists the team name, the total number of team members, the average probability of attrition, and the average predicted performance level in a table format. In some embodiments, a team may include only one worker.

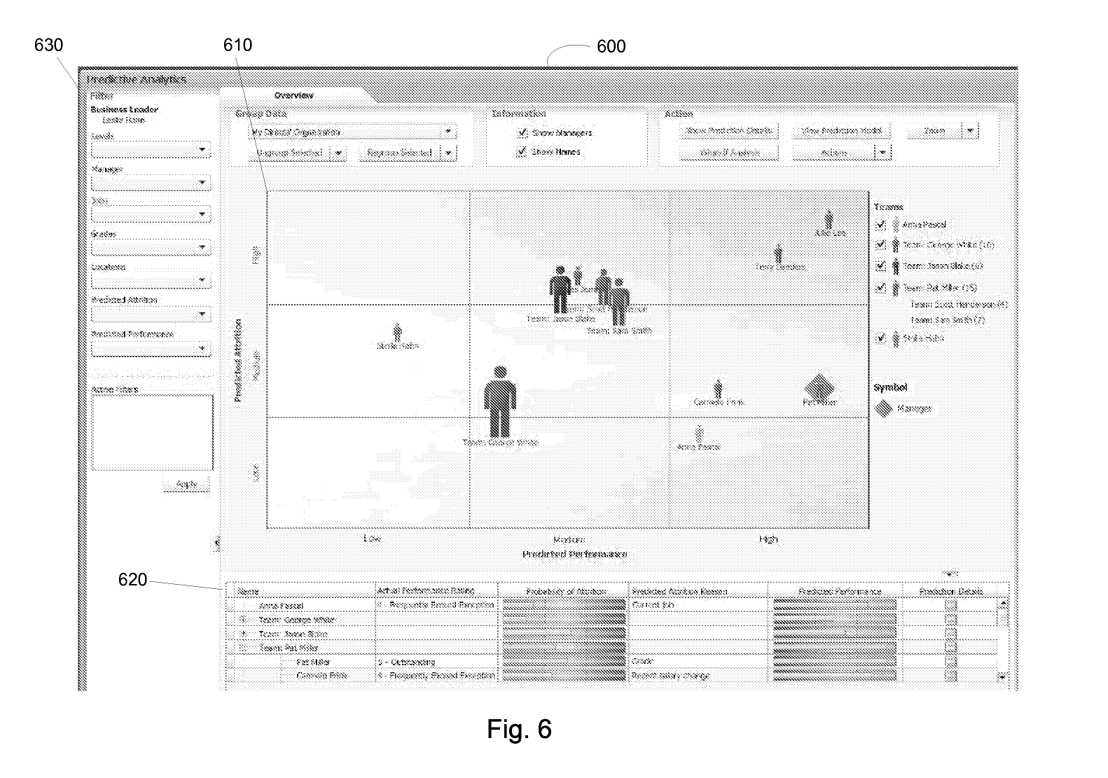

FIG. 6 illustrates another example of a predicted worker performance and attrition user interface 600 with additional information. In this example, chart view 610 shows the names of the workers under their representation and illustrates a prediction of their performance and likelihood of attrition based on the their representation's position on the graph. For instance, a worker placed in the right, bottom square on the graph has high predicted performance and low likelihood of attrition; while a worker in the center square of the graph would have medium predicted performance and a medium likelihood of attrition. Table view 620 lists the individual or team name, actual performance rating for the individual or team, the probability of attrition, the predicted attrition reason, the predicted performance level, and an icon for obtaining additional prediction details. In some embodiments, a filter area 630 is provided for filtering the results based, for example, on worker or team level, manager, jobs, grades, locations, predicted attrition, and predicted performance, as shown in

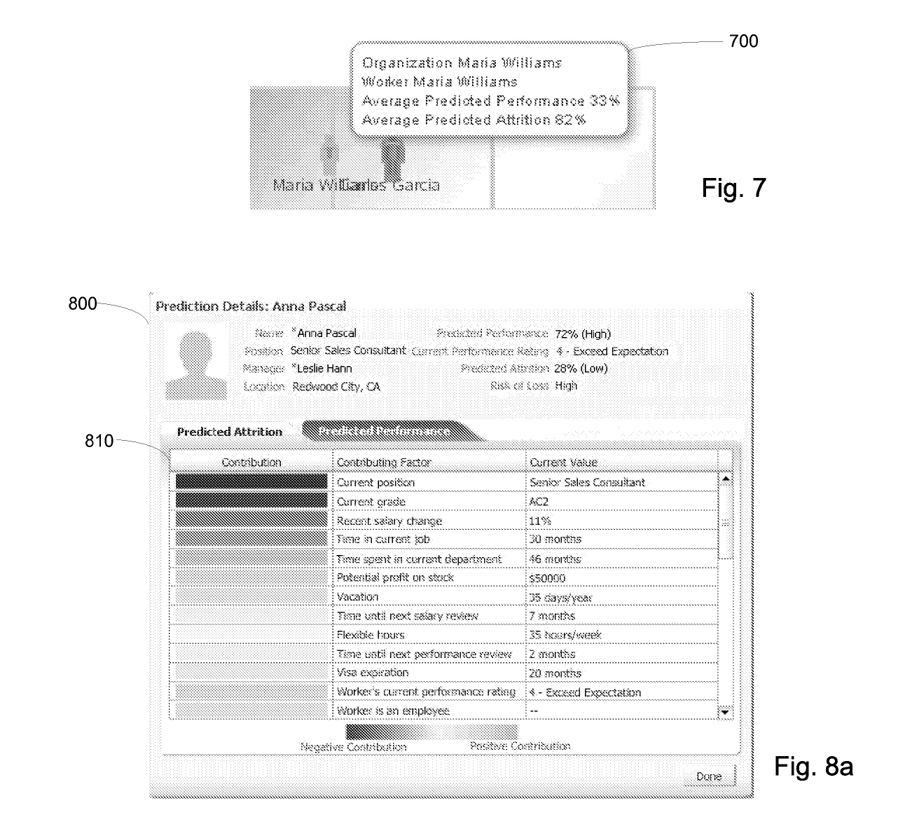

FIG. 7 illustrates a more detailed representation of chart view 510, 530, or 610, for example. As shown in FIG. 7, a window 700 with additional detail is shown, for example, when a cursor is hovered over a worker's depiction in chart view 510, 530, or 610. Window 700 may include information such as the worker's name, the worker's average predicted performance as a percentage, and the worker's average predicted attrition as a percentage.

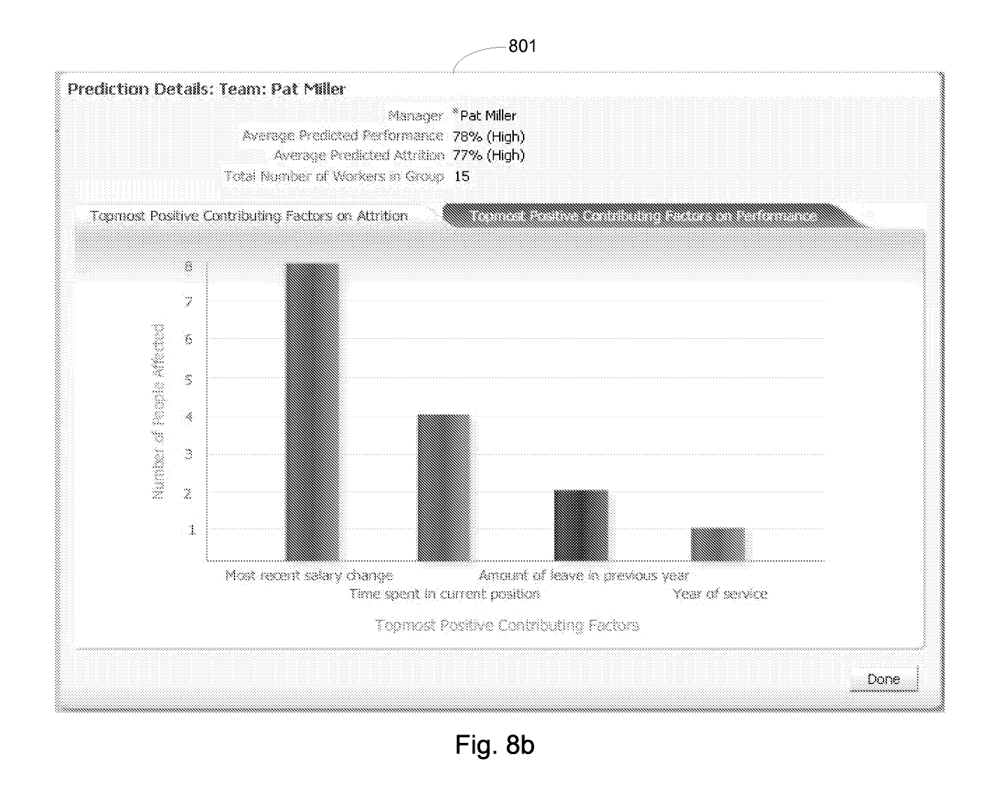

FIG. 8a illustrates an example of a pop-up dialogue box 800 that shows details related to an individual worker. In one embodiment, pop-up dialogue box 800 shows additional details related to the predicted attrition and predicted performance. For example, pop-up dialogue box 800 may list the worker's name, position, manager, location, predicted performance, current performance rating, predicted attrition, and risk of loss. Pop-up dialogue box 800 may also include a table 810 that illustrates contributing factors for the predicted attrition or performance, the current value of that factor, and the level of contribution of that factor (whether negative or positive) to the predicted attrition or performance.

FIG. 8b illustrates another example of a pop-up dialogue box 801 that shows details related to a worker or team. In this example, pop-up dialogue box 801 shows the details related to a team including the team manager, average predicted performance, average predicted attrition, and the total number of workers in the team. Pop-up dialogue box 801 may also include a graph that illustrates the topmost positive contributing factors to attrition and/or the topmost positive contributing factors to performance. In other embodiments, pop-up dialogue box 801 may illustrate a graph of the topmost negative contributing factors to attrition and/or the topmost negative contributing factors to performance.

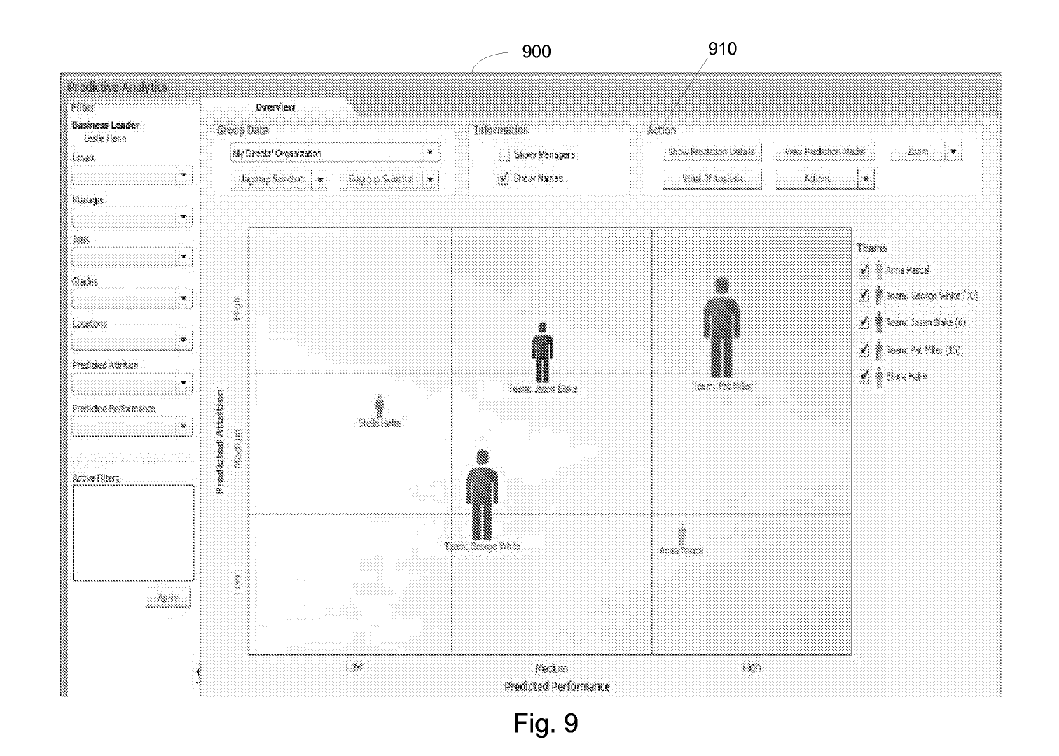

FIG. 9 illustrates an example of a predicted work area user interface 900 that a manager can use to further investigate a prediction associated with a worker or team. In one embodiment, different teams are identified with different colors. It is possible to filter out some teams and to highlight managers. In addition, it is possible to take some proposed action, such as promote or transfer, by selecting one of the buttons in action area 910.

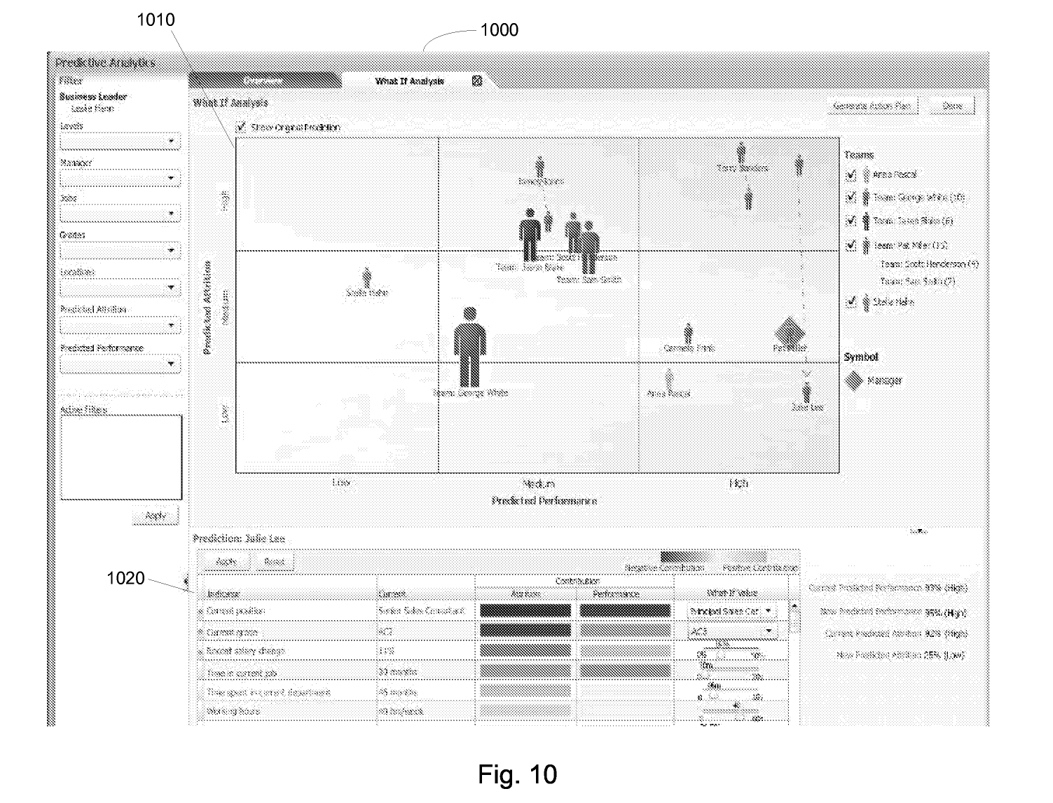

FIG. 10 illustrates an example of a predictive analytic dashboard user interface 1000 that displays the results of a what-if analysis based on proposed actions, such as providing a promotion or pay increase. The predictive analytic dashboard user interface 1000 allows a user to explore ways of changing a worker's predicted attrition and performance without actually taking any action. The chart of predictive analytic dashboard user interface 1000 can display the old prediction calculated by system 10, and also display the new prediction based on the proposed action. In other words, a manager can use predictive analytic dashboard user interface 1000 to enter a proposed personnel action, and the results of that proposed action will be displayed.

In some embodiments, the what-if column of table view 1020 lists any attributes involved in the prediction that a manager or user may want to change. These listed attributes may include some attributes that, in reality, a user cannot alter, such as length of service. However, the user might still be interested to see whether changing such an attribute will have a positive or negative effect on the worker.

For example, a manager can change a value in the what-if column of table view 1020 of predictive analytic dashboard user interface 1000 in order to view how that change will effect attrition and performance. In one embodiment, chart view 1010 will graphically display how such a change will effect performance and/or attrition of the employee. Additionally, predictive analytic dashboard user interface 1000 can display the effect of any action on other members of team so that the manager can see the wider effects of any change.

The contribution column of table view 1020 indicates an attributes level of contribution to the likelihood of attrition and future performance. In this example, the attributes in the what-if column are listed in descending order of the percentage contribution to the probability of attrition, but this order may be changed by the user. The user can change any of the attributes in the what-if column and see the effect on the predictions, both in the table view 1020 and on chart view 1010. In one embodiment, the contributions columns in the table will not change as the user changes values in the what-if column.

Once the manager is pleased with the actions they have proposed, predictive analytic dashboard user interface 1000 can generate a list of the actions the manager specified during the what-if analysis, or it will allow the manager to initiate an action. In another embodiment, system 10 can calculate the optimum actions to be taken by automatically changing what-if values until the optimum desired result is achieved. According to certain embodiments, the user decides which attributes are to be included in the calculation by system 10 and whether any constraints are to placed on those attributes. For instance, a user might specify a constraint that the salary can only vary between −5% to 10% of the worker's current salary.

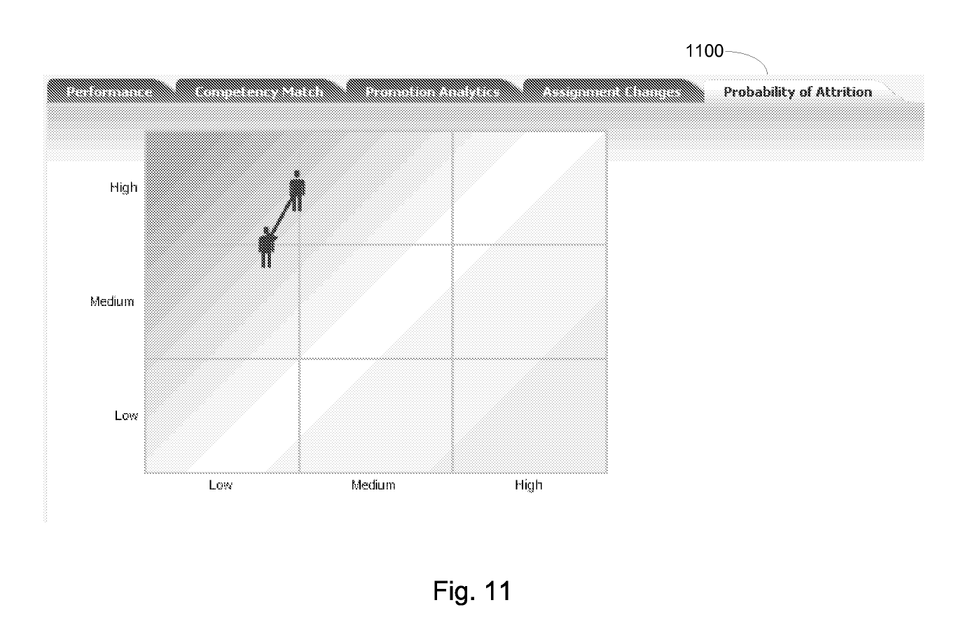

FIG. 11 illustrates an example of a probability of attrition graph 1100 according to one embodiment. According to this embodiment, the manager can view the worker's predicted attrition and performance both before and after the proposed action. For example, each time the manager changes an attribute, such as a grade change or salary change, the probability of attrition graph 1100 is updated to show the effect of the change. Similar to FIG. 5, the y-axis of the probability of attrition graph 1100 shows the predicted attrition, while the x-axis shows the predicted performance. In addition, the effect of an action on the rest of the team may also be illustrated by the probability of attrition graph 1100.

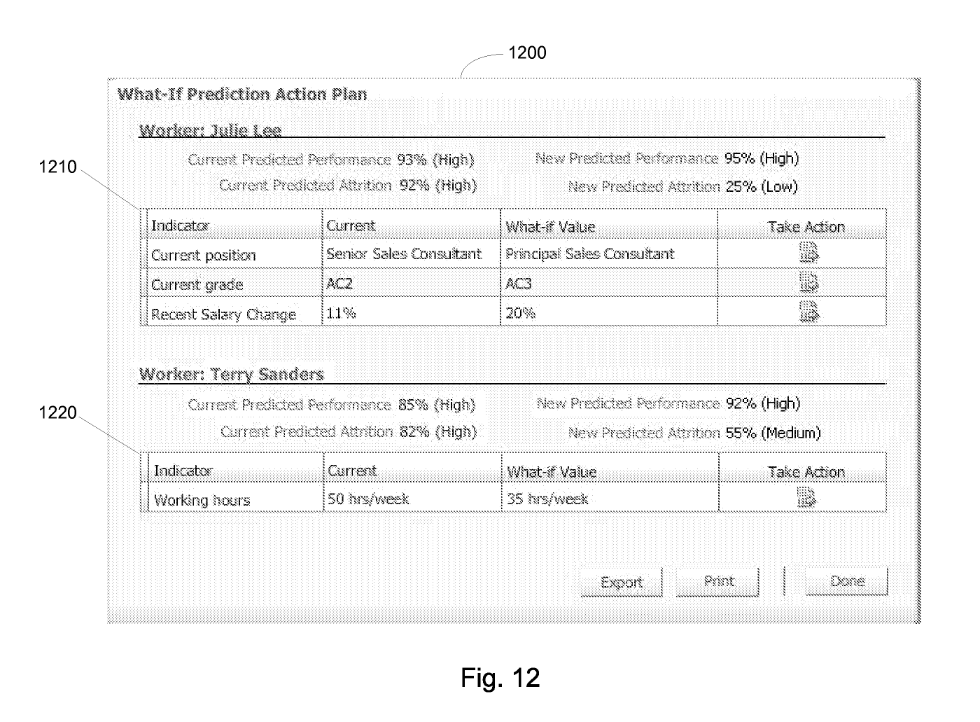

FIG. 12 illustrates a what-if prediction action plan user interface 1200 according to one embodiment. What-if prediction action plan user interface 1200 can include a table that lists a current and proposed attribute for a worker. In this example, the current column of table 1210 lists the worker's current position, grade, and recent salary change. What-if prediction action plan user interface 1200 shows the current predicted performance and current predicted attrition based on the worker's current attributes. The what-if value column of table 1210 lists proposed attributes for a worker, which may include a promotion and larger salary change. What-if prediction action plan user interface 1200 also shows the new predicted performance and new predicted attrition based on the proposed attributes. According to this example, a user can see that the proposed attributes will result in a slight increase in performance and a large reduction in the likelihood of attrition.

Similarly, table 1220 of what-if prediction action plan user interface 1200 shows the current working hours for a worker, and their current performance and current attrition values. Table 1220 also shows proposed working hours, and new performance and new attrition values based on that proposed change. Tables 1210 and 1220 also include a take action column that allows a user to click the icon shown in that column to execute the proposed action.

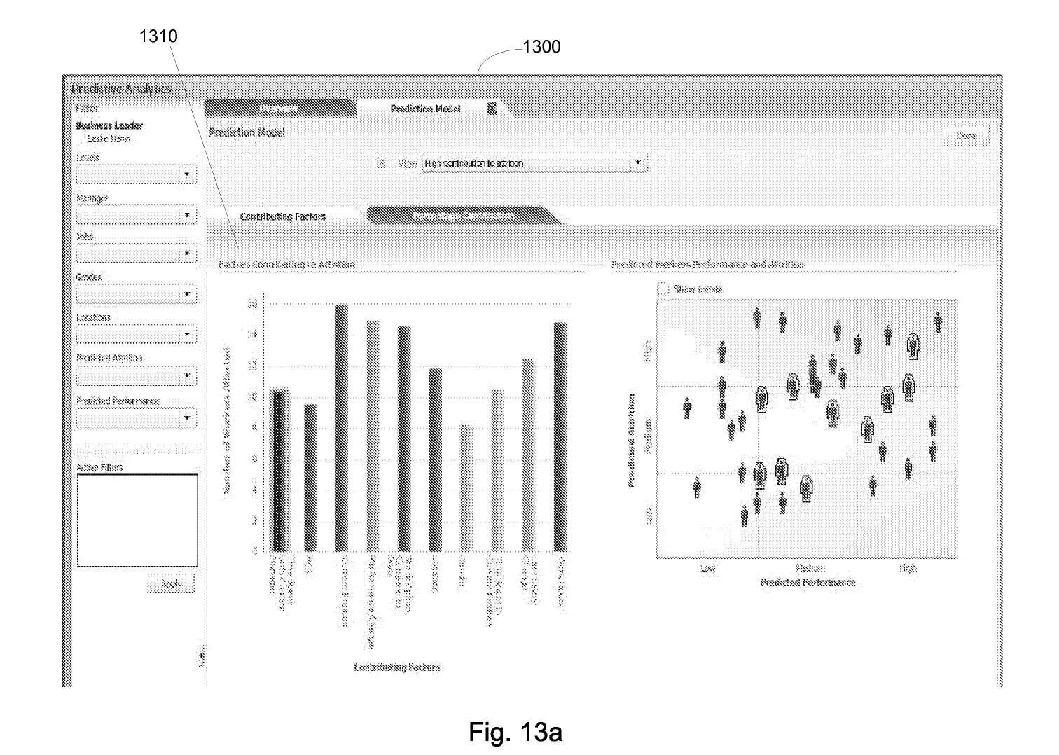

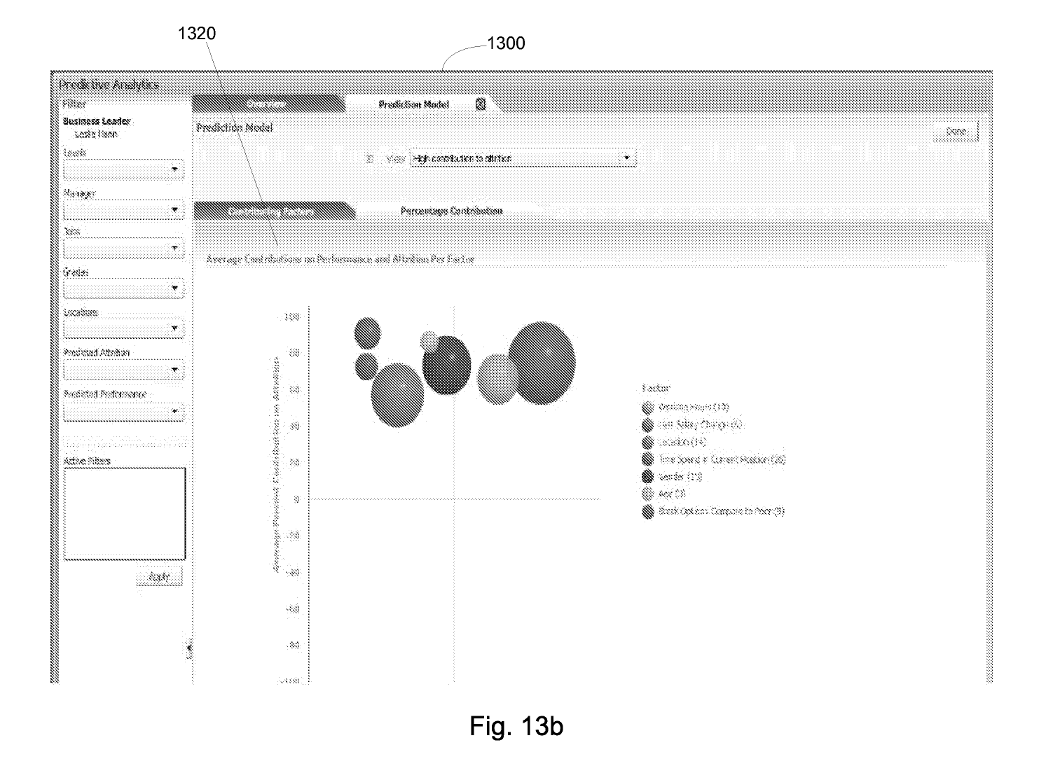

FIG. 13a illustrates a predictive model user interface 1300 according to one embodiment. Predictive model user interface 1300 shows the factors contributing to attrition in a bar graph 1310. Bar graph 1310 lists the contributing factors on the x-axis and the number of workers affected on the y-axis. As a result, bar graph 1310 shows the number of workers affected by each contributing factor to attrition. As illustrated in FIG. 13b, predictive model user interface 1300 can also show each factor's average percent contribution to attrition in graph 1320.

In view of the above, embodiments of the invention provide a useful system for predicting both the likelihood that an employee leaves a company and their future performance. In one example, the system utilizes data mining tools to analyze employee attributes to determine a link between those attributes and some future characteristic of the employees. The system then uses the results of that data mining analysis to predict whether a specific employee is likely to leave as well as their likely future performance. Other embodiments of the system allow managers to predict the results of a personnel action on an employee or group prior to officially taking that action.

It should be noted that many of the functional features described in this specification have been presented as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be partially implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve its stated purpose.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A computer-readable media having instructions stored thereon that, when executed by a processor, causes the processor to execute the instructions comprising:
collecting a plurality of attributes associated with each of a plurality of workers;
applying a data mining tool to the attributes to identify a pattern between the attributes and a future characteristic of the workers; and
using the identified pattern to predict the future characteristic of a worker.

2. The computer-readable medium according to claim 1, wherein the future characteristic comprises future performance of the worker.

3. The computer-readable medium according to claim 1, wherein the future characteristic comprises a future likelihood of attrition of the worker.

4. The computer-readable medium according to claim 2, wherein the data mining tool comprises a regression technique.

5. The computer-readable medium according to claim 4, wherein the regression technique comprises a support vector machine.

6. The computer-readable medium according to claim 3, wherein the data mining tool comprises a classification technique.

7. The computer-readable medium according to claim 6, wherein the classification technique comprises a generalized linear model.

8. A computer-implemented method, comprising:
collecting a plurality of attributes associated with each of a plurality of workers;
applying a data mining tool to the attributes to identify a pattern between the attributes and a future characteristic of the workers; and
using the identified pattern to predict the future characteristic of a worker.

9. The method according to claim 8, wherein the future characteristic comprises future performance of the worker.

10. The method according to claim 8, wherein the future characteristic comprises a future likelihood of attrition of the worker.

11. An apparatus, comprising:
memory configured to store a plurality of attributes associated with each of a plurality of workers;
a processor configured to
apply a data mining tool to the attributes to identify a pattern between the attributes and a future characteristic of the workers; and
use the identified pattern to predict the future characteristic of a worker.

12. The apparatus according to claim 11, wherein the future characteristic comprises future performance of the worker.

13. The apparatus according to claim 11, wherein the future characteristic comprises a future likelihood of attrition of the worker.
